(19) United States
(12) Patent Application Publication
(10) Pub. No.: US 2025/0126522 A1
(43) Pub. Date: Apr. 17, 2025

(54) NETWORK SLICE CONTROLLER FOR A WIRELESS COMMUNICATION NETWORK

(71) Applicant: T-MOBILE INNOVATIONS LLC, Overland Park, KS (US)

(72) Inventors: Marouane Balmakhtar, Fairfax, VA (US); Lyle Walter Paczkowski, Mission Hills, KS (US); Galip Murat Karabulut, Vienna, VA (US)

(21) Appl. No.: 18/484,646

(22) Filed: Oct. 11, 2023

(51) Int. Cl. H04W 28/08; H04W 28/02; H04W 28/10; H04W 28/24

(52) U.S. Cl. CPC H04W 28/0958; H04W 28/0289; H04W 28/10; H04W 28/24

(57) ABSTRACT

Various embodiments comprise a wireless communication network to dynamically manage network slices. The wireless communication network comprises a Network Slice Control Function (NSCF). The NSCF retrieves network slice Key Performance Indicators (KPIs) that indicate traffic patterns and network parameters related to a wireless network slice. The NSCF generates a prediction of network conditions for the wireless network slice based on the network slice KPIs. The NSCF updates one or more network slice parameters for the wireless network slice based on the prediction. The NSCF modifies the wireless network slice based on the one or more updated network slice parameters.

### TECHNICAL FIELD

Various embodiments of the present technology relate to network slicing, and more specifically, to predicting network conditions and proactively controlling wireless network slices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources to provide a specific service. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), and Massive Internet-of-Things (MIoT). By implementing network slicing, wireless communication networks optimize the computing and radio resources for specific service types thereby enhancing the overall user experience.

Wireless communication networks are dynamic environments. The number of user devices active on a network and the services requested by the active user devices can vary greatly. When networks experience upticks in the number of active users and/or an uptick in requests for a specific service type, network slices dedicated to providing that service type can become overloaded. Overloaded network slices may experience increased latency, increased packet loss, degraded security capabilities, and/or other types of service degradations. These service degradations negatively impact the user experience.

Unfortunately, wireless communication networks do not efficiently control network slices in response to changing network conditions. Moreover, wireless communication networks do not effectively predict when network conditions will occur that affect network slices.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method of operating a wireless communication network to dynamically manage network slices. The method comprises retrieving network slice Key Performance Indicators (KPIs) that indicate traffic patterns and network parameters related to a wireless network slice. The method further comprises generating a prediction of network conditions for the wireless network slice based on the network slice KPIs. The method further comprises updating one or more network slice parameters for the wireless network slice based on the prediction. The method further comprises modifying the wireless network slice based on the one or more updated network slice parameters.

Some embodiments comprise a wireless communication network configured to dynamically manage network slices. The wireless communication network comprises a Network Slice Control Function (NSCF). The NSCF retrieves network slice KPIs that indicate traffic patterns and network parameters related to a wireless network slice. The NSCF generates a prediction of network conditions for the wireless network slice based on the network slice KPIs. The NSCF updates one or more network slice parameters for the wireless network slice based on the prediction. The NSCF modifies the wireless network slice based on the one or more updated network slice parameters.

Some embodiments comprise one or more non-transitory computer-readable storage media having program instructions stored thereon to dynamically manage network slices. When executed by a computing system, the program instructions direct the computing system to perform operations. The operations comprise retrieving network slice KPIs that indicate traffic patterns and network parameters related to a wireless network slice. The operations further comprise generating a prediction of network conditions for the wireless network slice based on the network slice KPIs. The operations further comprise updating one or more network slice parameters for the wireless network slice based on the prediction. The operations further comprise modifying the wireless network slice based on the one or more updated network slice parameters.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates communication network to dynamically manage network slices.

FIG. 2 illustrates an exemplary operation of the communication network to dynamically manage network slices.

FIG. 3 illustrates a wireless communication network to dynamically manage network slices.

FIG. 4 illustrates an exemplary operation of the wireless communication network to dynamically manage network slices.

FIG. 5 illustrates a control plane, user plane, Network Data Analytics Function (NWDAF), and Network Slice Control Function (NSCF) in the wireless communication network.

FIG. 6 illustrates a Fifth Generation (5G) communication network to dynamically manage network slices.

FIG. 7 illustrates a 5G User Equipment (UE) in the 5G communication network.

FIG. 8 illustrates a 5G Radio Access Network (RAN) in the 5G communication network.

FIG. 9 illustrates network functions in the 5G communication network.

FIG. 10 illustrates a Network Function Virtualization Infrastructure (NFVI) in the 5G communication network.

FIG. 11 further illustrates the NFVI in the 5G communication network.

FIG. 12 illustrates an exemplary operation of the 5G communication network to dynamically manage network slices.

FIG. 13 illustrates an exemplary operation of the 5G communication network to dynamically manage network slices.

FIG. 14 illustrates an exemplary operation of the 5G communication network to dynamically manage network slices.

FIG. 15 illustrates an exemplary operation of the 5G communication network to dynamically manage network slices.

FIG. 16 illustrates an exemplary operation of the 5G communication network to dynamically manage network slices.

FIG. 17 illustrates an exemplary operation of the 5G communication network to dynamically manage network slices.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

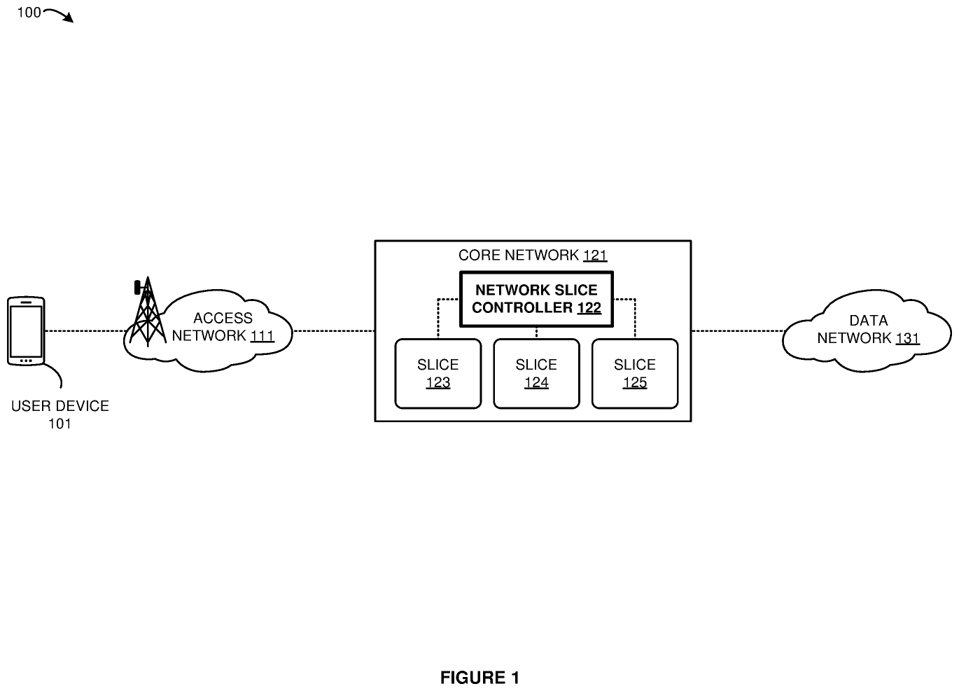

FIG. 1 illustrates communication network 100 to dynamically manage network slices. Communication network 100 delivers services like media-streaming, internet-access, voice/video calling, text messaging, machine communications, or some other wireless communications product. Communication network 100 comprises user device 101, access network 111, core network 121, and data network 131. Core network 121 comprises network slice controller 122 and network slices 123-125. In other examples, communication network 100 may comprise additional or different elements than those illustrated in FIG. 1.

Various examples of network operation and configuration are described herein. In some examples, network slice controller 122 controls the operations of network slices 123-125. Slices 123-125 are representative of collections of hardware and software resources in network 100 to provide services to user device 101. Each of slices 123-125 may be configured to provide specific service types. For example, slice 123 may comprise hardware and software resources optimized for low-latency communications to provide low-latency data services to user device 121 while slice 124 may comprise a set of hardware and software resources optimized for online gaming to provide online gaming services to user device 121. Network slice controller 122 identifies traffic patterns, network parameters, and/or other data relating to network slices 123-125. For example, network slice controller 122 may receive data (e.g., Key Performance Indicators (KPIs)) indicating bandwidth utilization, latency, packet loss, and throughput to identify traffic patterns and network parameters for slices 123-125. Network slice controller 122 predicts network conditions for slices 123-125 based on the identified traffic patterns and network parameters. Slice controller 122 updates the operating parameters for slices 123-125 based on the prediction. For example, slice controller 122 may track when the operating metrics for slices 123-125 exceed operating thresholds and then predict imminent network congestion on slice 123-125. Controller 122 may responsively increase the available bandwidth utilization for slice 123-125 in anticipation of the network congestion.

Communication network 100 provides wireless data services to wireless user devices like user device 101. Exemplary wireless data services include internet-access, media-streaming, social-networking, and machine-control. Exemplary wireless user devices comprise phones, computers, vehicles, robots, and sensors. Access network 111 comprises an example of a Radio Access Network (RAN). RANs exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores like core network 121. The RANs are connected to the wireless network cores over backhaul data links. Access network 111 and core network 121 may communicate via edge networks like internet backbone providers, edge computing systems, or another type of edge system to provide the backhaul data links between node 111 and core network 121.

The RANs (e.g., access network 111) comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 121.

Core network 121 and data network 131 are representative of computing systems that provide wireless data services to user device 101 over access network 111. Exemplary computing systems comprise Network Function Virtualization (NFVI) systems, data centers, server farms, cloud computing networks, hybrid cloud networks, and the like. The computing systems of core network 121 store and execute the network functions to form network slice controller 122 and network slices 123-125. Slices 123-125 provide wireless data services to user device 101 over access network 111. Network slice controller 122 monitors core network 121 to predict emerging network conditions and proactively adjust the operation of slices 123-125 based on the predicted network conditions. Controller 122 and slices 123-125 may comprise network functions like Access and Mobility Management Function (AMF), Session Management Function (SMF), User Plane Function (UPF), Network Slice Selection Function (NSSF), Network Slice Management Function (NSMF), Network Data Analytics Function (NWDAF), and Network Slice Control Function (NSCF), Network Exposure Function (NEF), Application Function (AF), and the like. Core network 121 may comprise a Fifth Generation Core (5GC) architecture or another type of core network architecture. Data network 131 is representative of the communication endpoint for user device 101. The computing systems of data network 131 comprise application servers that host various application types to serve user device 101.

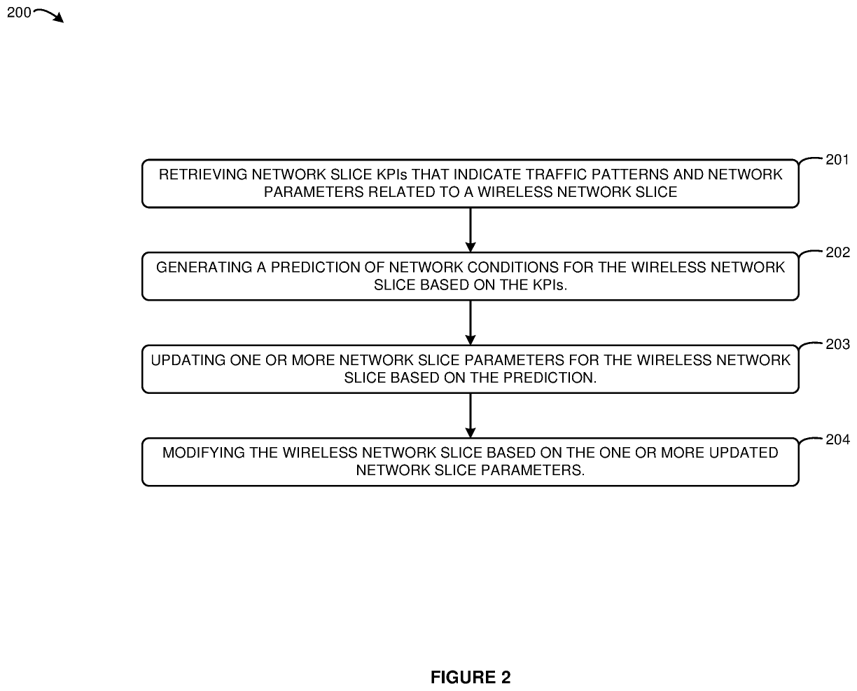

FIG. 2 illustrates process 200. Process 200 comprises an exemplary operation of communication network 100 to dynamically manage network slices. The operation may vary in other examples. The operations of process 200 comprise retrieving network slice KPIs that indicate traffic patterns and network parameters related to a wireless network slice (step 201). The operations further comprise generating a prediction of network conditions for the wireless network slice based on the KPIs (step 202). The operations further comprise updating one or more network slice parameters for the wireless network slice based on the prediction (step 203). The operations further comprise modifying the wireless network slice based on the one or more updated network slice parameters (step 204).

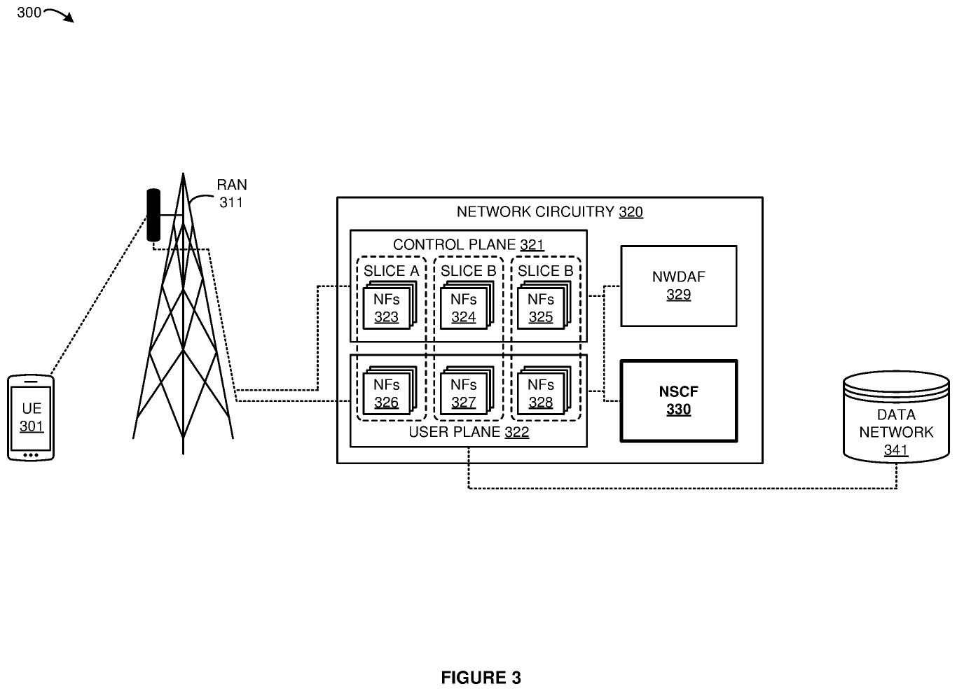

FIG. 3 illustrates wireless communication network 300 network to dynamically manage network slices. Wireless communication network 300 is an example of communication network 100, however network 100 may differ. Wireless communication network 300 comprises User Equipment (UE) 301, RAN 311, network circuitry 320, and data network 341. Network circuitry 320 comprises control plane 321, user plane 322, NWDAF 329, and NSCF 330. Control plane 321 comprises network functions (NFs) 323-325. User plane 322 comprises network functions 326-328. As illustrated in FIG. 3, network functions 323 and 326 form slice A, network functions 324 and 327 form slice B, and network functions 325 and 328 form slice C. In other examples, wireless network communication network 300 may comprise additional or different elements than those illustrated in FIG. 3.

In some examples, NSCF 330 retrieves network slice KPIs that indicate traffic patterns and network parameters related to network slices A, B, and C. For example, network functions 323-328 may report performance and status data to NWDAF 329 and NSCF 330 may query NWDAF 329 for slice relevant portions of the performance and status data reported by network functions 323-328. NSCF 330 generates a prediction of network conditions for the slices based on the KPIs. Exemplary predictions include predicting network congestion, predicting security violations, predicting third-party needs, and the like. NSCF 330 selects updated slice parameters for slices A, B, and C based on the prediction. For example, NSCF 330 may predict imminent network congestion based on the time of day and NSCF 330 may reduce the Quality-of-Service (QoS) of slice to handle the imminent network congestion. NSCF 330 modifies the slices A, B, and C based on the updated network slice parameters.

Advantageously, wireless communication network 300 efficiently controls network slices in to preempt network conditions like network congestion or security violations from adversely affecting user experience. Moreover, wireless communication network 300 effectively predicts when network conditions will occur that affect network slices.

UE 301 and RAN 311 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 311, network circuitry 320, and data network 341 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a vehicle, drone, robot, computer, phone, sensor, or another type of data appliance with wireless and/or wireline communication circuitry. Although RAN 311 is illustrated as a tower, RAN 311 may comprise another type of mounting structure (e.g., a building), or no mounting structure at all. RAN 311 comprises a Fifth Generation (5G) RAN, LTE RAN, gNodeB, eNodeB, NB-IoT access node, trusted non-Third Generation Partnership Project (3GPP) access node, untrusted non-3GPP access node, LP-WAN base station, wireless relay, WIFI hotspot, Bluetooth access node, and/or another wireless or wireline network transceiver. UE 301 and RAN 311 comprise antennas, amplifiers, filters, modulation, analog/digital interfaces, microprocessors, software, memories, transceivers, bus circuitry, and the like. Network functions 323-325 of control plane 321 comprises network functions like AMF, SMF, NSSF, NSMF, NEF, AF, and the like. Network functions of user plane 322 comprises network functions like UPF and the like. Data network 341 comprises application servers that host applications like media streaming applications, social media applications, low-latency applications, voice/video conferencing applications, online gaming applications, extended/virtual reality applications, and the like.

UE 301, RAN 311, network circuitry 320, and data network 341 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 300 as described herein.

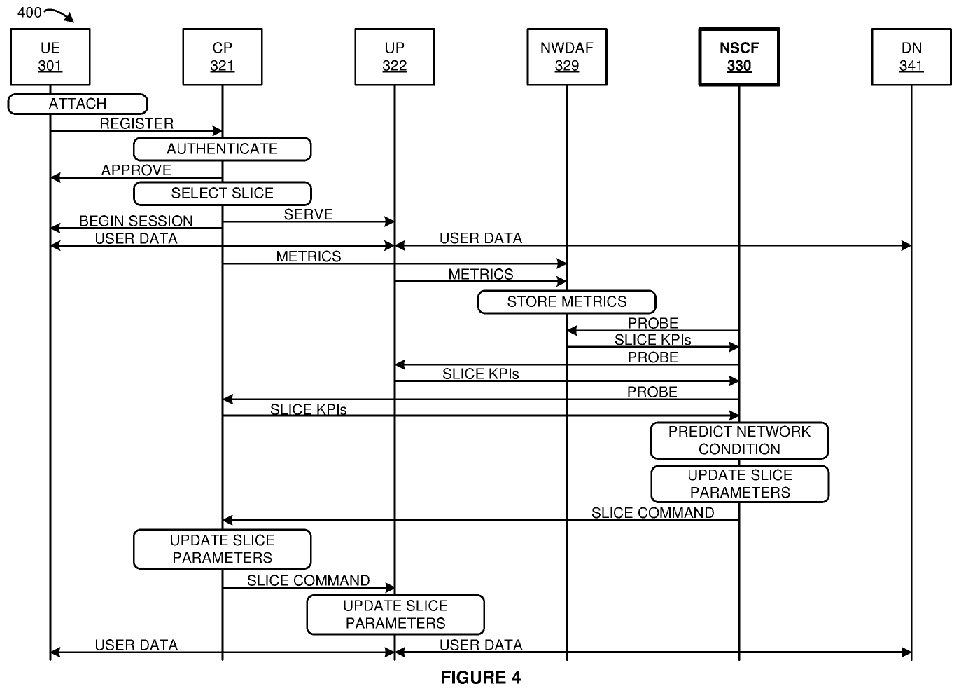

FIG. 4 illustrates process 400. Process 400 comprises an exemplary operation of wireless communication network 300 to dynamically manage network slices. The operation may vary in other examples. In some examples, UE 301 attaches to RAN 311 and transfers a registration request to control plane 321. The registration request includes slices requests for network slices A, B, and C. Control plane 321 authenticates the identity of UE 301. In response, control plane 321 registers UE 301 on network circuitry 320 and transfers a registration approval message to UE 301 over RAN 311. Control plane 321 compares the slices requested by UE 301 in the registration request to the slices authorized for UE 301 to use and responsively selects slices A, B, and C. For example, UE 301 may include Network Slice Selection Assistance Information (NSSAI) for slices A, B, and C. Control plane 321 may compare the NSSAIs provided by UE 301 to allowed NSSAIs indicated by the subscriber profile for UE 301. Control plane 321 may select slices A, B, and C when the requested NSSAIs match the allowed NSSAIs. Once the slices are selected, control plane 321 directs the network functions in control plane 321 and in user plane 322 that compose slices A, B, and C to serve UE 301. Control plane 321 directs UE 301 to begin the data sessions on slices A, B, and C. UE 301 exchanges user data with the network functions of user plane 322 that compose slices A, B, and C. The user plane network functions exchange the user data with application servers in data network 341.

Network functions 323-328 are subscribed to NWDAF 329 to report service metrics that quantify the performance and operation on functions 323-328. For example, network functions 323-328 may report metrics like slice bandwidth utilization, throughput, packet loss, latency, QoS level, percent processor load, percent memory occupancy, and the like. Control plane 321 and user plane 322 report service metrics, network parameters, and the like to NWDAF 329. NWDAF 329 receives and stores the metrics as network analytics data.

To predict imminent network conditions and preemptively adjust the operating parameters of slices A, B, and C, NSCF 330 probes control plane 321, user plane 322, and NWDAF 329 for slice KPIs. For example, NSCF 330 may transfer Application Programming Interface (API) calls for slice KPIs to predict network congest, security violations, or other changes in slice operation that can adversely affect user experience. The slice KPIs comprise latency, throughput, packet loss, bandwidth utilization, and slice security parameters like authentication success rate, access control violations (e.g., the number of unauthorized access attempts detected within the wireless network slice), security patch compliance % (e.g., the percent of network functions and elements making up the wireless network slice that are up to date with security patches), and the like. Control plane 321, user plane 322, and NWDAF 329 respond to the probes with the requested KPIs. NSCF 330 predicts network conditions for slices A, B, and C based on the KPIs and updates slice parameters for slices A, B, and C based on the network conditions. The updated slice parameters typically comprise an adjustment to bandwidth utilization or a QoS adjustment, however other adjustments like instantiating additional computing resources or modifying slice security protocols (e.g., updated authentication procedures) may be made. For example, NSCF 330 may determine slice A lacks additional bandwidth and in response, instantiate an additional network slice (e.g., slice D) to respond to network congestion. For example, NSCF 330 may detect an increase in access control violations on slice B and in response, update the authentication procedure used to access slice B.

NSCF 330 transfers a slice command that comprises the updated slice parameters selected by NSCF 330 to control plane 321. The slice command directs control plane 321 to modify slices A, B, and C using the updated slice parameters. Control plane 321 receives the command and updates the control plane elements of slices A, B, and C. Control plane 321 directs the user plane elements of slices A, B, and C to implement the updated slice parameters. UE 301 exchanges additional user data with the network functions of user plane 322 that compose updated slices A, B, and C. The user plane network functions exchange the additional user data with application servers in data network 341.

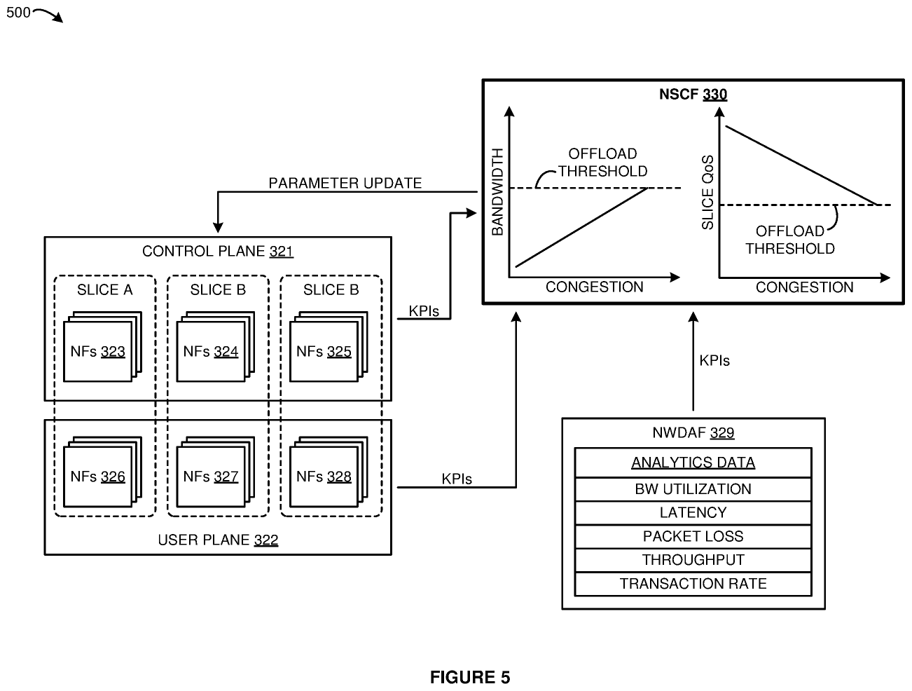

FIG. 5 illustrates an exemplary operation of control plane 321, user plane 322, NWDAF 329, and NSCF 330 in wireless communication network 300. In some examples, NSCF 330 receives KPIs from control plane network functions 323-325, user plane network functions from network functions 326-328, and NWDAF 329. The KPIs comprise operational measurements, performance measurements, analytics data, and/or other metrics that describe network conditions that can affect network slices A, B, and C. NWDAF 329 stores analytics data that includes bandwidth (BW) utilization, latency, packet loss, throughput, and transaction rate. The KPIs reported by NWDAF 329 may differ from the KPIs reported by control plane 321 and user plane 322. For example, NWDAF 329 may store and report network averages (e.g., average latency of slice B) while the KPIs reported by control plane 321 and user plane 322 may comprise near-real time KPIs (e.g., current network function processor load). In some examples, NSCF 330 may retrieve KPIs from non-network function sources (e.g., from RAN 311) that interact with and compose slices A, B, and C.

NSCF 330 hosts a data structure that implements the graphs illustrated in FIG. 5. The graphs correlate predicted network congestion to updated slice parameters. As illustrated in the left-side graph, as the predicted network congestion increases, the updated bandwidth utilization for a slice also increases. As illustrated in the right-side graph, as predicted network congestion increases, updated slice QoS decreases. Both graphs comprise an offload threshold. When predicted network congestion exceeds the offload threshold, NSCF 330 instantiates a new network slice to offload some or all of the users on that slice. Such situations may occur when the excess bandwidth of a given slice has been exhausted and/or when a given slices QoS has reached a minimum acceptable QoS.

NSCF 330 processes the KPIs to predict future network congestion that will affect slices A, B, and C. NSCF 330 inputs the predicted network congestion into the data structure which outputs an updated bandwidth and updated slice QoS for slices A, B, and C. NSCF 330 transfers the updated slice parameters to control plane 321 and directs control plane 321 to modify the bandwidth and QoS of slices A, B, and C using the updated parameters.

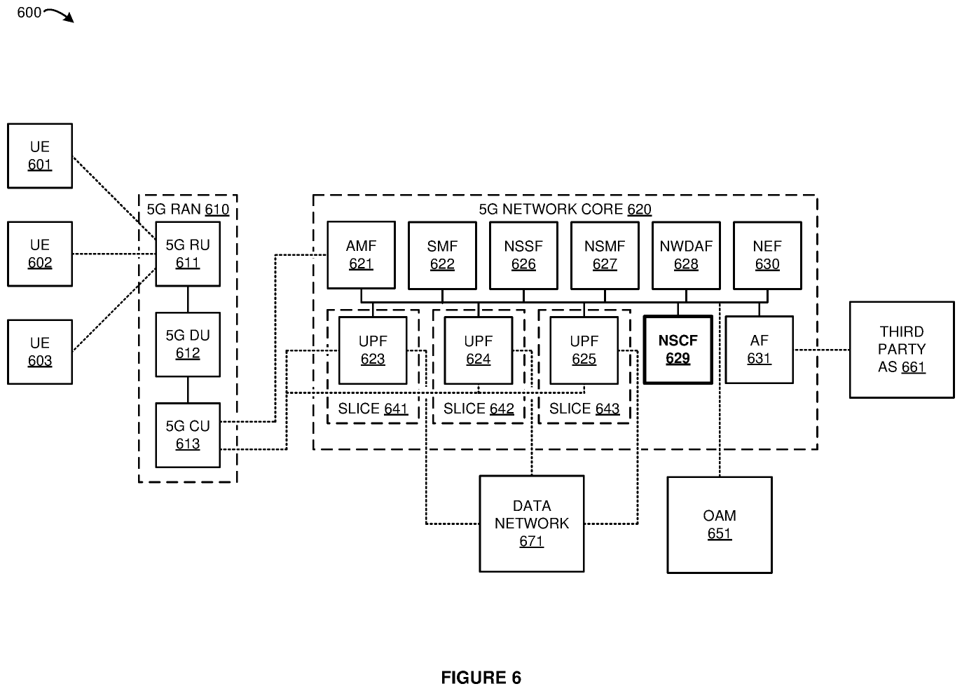

FIG. 6 illustrates 5G communication network 600 to dynamically manage network slices. 5G communication network 600 comprises an example of communication network 100 illustrated in FIG. 1 and wireless communication network 300 illustrated in FIG. 3, however networks 100 and 300 may differ. 5G Communication network 600 comprises 5G UEs 601-603, 5G RAN 610, 5G network core 620, Orchestration and Management (OAM) 651, third-party Application Server (AS) 661, and data network 671. 5G RAN 610 comprises Radio Unit (RU) 611, Distributed Unit (DU) 612, and Centralized Unit (CU) 613. 5G network core 620 comprises Access and Mobility Management Function (AMF) 621, Session Management Function (SMF) 622, User Plane Functions (UPFs) 623-625, Network Slice Selection Function (NSSF) 626, Network Slice Management Function (NSMF) 627, Network Data Analytics Function (NWDAF) 628, Network Slice Control Function (NSCF) 629, Network Exposure Function (NEF) 630, and Application Function (AF) 631. UPF 623 corresponds to slice 641, UPF 624 corresponds to slice 642, and UPF 625 corresponds to slice 643. Other network functions and network entities like Network Repository Function (NRF), Session Communication Proxy (SCP), Authenticating Server Function (AUSF), Policy Control Function (PCF), and Unified Data Management (UDM) are typically present in 5G network core 620 but are omitted for clarity. In other examples, 5G communication network 600 may comprise different or additional elements than those illustrated in FIG. 6.

In some examples, UE 601 wirelessly attaches to RAN 610. UE 601 transfers a registration request to AMF 621 over RAN 610. The registration request includes information like registration type, UE capabilities, NSSAI requests, Protocol Data Unit (PDU) session requests, and the like. In response to the registration request, AMF 621 transfers an identity request to UE 601 over RAN 610. UE 601 indicates its identity to AMF 621 over RAN 610. Exemplary identity indications include Subscriber Concealed Identifier (SUCI) and the like. AMF 621 interacts with other network functions to authenticate the identity of UE 601 and authorize UE 601 for wireless data service. For example, AMF 621 may transfer an authentication request to an AUSF that includes the SUCI of UE 601. The AUSF may then interface with a UDM to retrieve authentication data to verify the SUCI of UE 601. The authentication data typically comprises the Subscriber Permanent Identifier (SUPI) for UE 601 and authentication vectors like an authentication challenge, key selection criteria, and a random number. The AUSF then transfers the authentication data and SUPI to AMF 621. AMF 621 may transfer an authentication challenge, key selection criteria, and random number to UE 601 over RAN 610. UE 601 may hash the random number using its copy of the secret key to generate an authentication response and transfer the response to AMF 621 over RAN 610. AMF 621 may authenticate UE 601 by matching the authentication response generated by UE 601 with the expected result.

Responsive to the authentication, AMF 621 registers UE 601 for service on network 600. AMF 621 accesses a subscriber profile for UE 601 to form UE context for UE 601. For example, AMF 621 may select a UDM that manages the subscriber profile for UE 601. AMF 621 may transfer a context get request to the UDM to retrieve data like QoS metrics, allowed NSSAI, service attributes, service authorizations, and the like from the UDM. The UDM returns the requested information to AMF 621 which generates UE context comprising the information retrieved from the UDM. AMF 621 may additionally select and register with a PCF to create a network policy association for UE 601.

Once the context is generated AMF 621, AMF 621 selects NSSF 626 to select network slices for UE 601. AMF 621 transfers a get request to NSSF 626 to map the NSSAI requested by UE 601 to available network slices (e.g., slices 641-643) in network core 620. NSSF 626 receives the request and maps the NSSAI included in the get request to one or more of slices 641-643. NSSF 626 returns the slice mappings to AMF 621 which then selects corresponding ones of slices 641-643. For example, slice 641 may comprise an Ultra Reliable Low Latency Communications (URLLC) slice, slice 642 may comprise an Enhanced Mobile Broadband (eMBB) slice, and UE 601 may include NSSAI for an URLLC slice and an eMBB slice in the initial registration request. NSSF 626 may map the NSSAI information in the get request to network slices 641 and 642 to identify network slices for UE 601.

Slices 641-643 may comprise URLLC slices, eMBB slices, Massive Internet-of-Things (MIoT) slices, metaverse slices, media streaming slices, security slices, gaming slices, and the like. Although slices 641-643 are illustrated as comprising only UPFs 641-643, in other examples slices 641-643 may comprise additional network functions or RAN elements in network 600. For example, network core 620 may comprise multiple AMFs and SMFs and slices 641-643 may each comprise an AMF and an SMF in addition to UPFs 623-625. When slices 641-643 comprise multiple network functions, some of the network functions may be shared between the network slices. For example, slices 641 and 642 may each comprise SMF 622 while slice 643 comprises another SMF. It should be appreciated that slices 641-643 illustrated in FIG. 6 are exemplary and the slice configuration implemented by network core 620 may differ in other examples. Slices 641-643 may comprise a horizontal slice configuration or a vertical slice configuration. In horizontal slicing, a network slice is configured to provide a particular service to a class of devices. For example, slice 641 may comprise a MIoT slice that provides IoT services to a variety of IoT devices. In vertical slicing, a network slice is configured to provide a set of services to specific devices. For example, slice 641 may comprise capabilities for low-latency and extended reality communications to support user devices participating in a metaverse session.

Returning to the example, AMF 621 selects SMF 622 to serve UE 601 based on the selected network slice, QoS metrics, requested PDU sessions, service attributes, and the like. AMF 621 directs SMF 622 to establish PDU sessions for UE 601 and indicates the slice IDs for the selected ones of slices 641-643 to SMF 622. SMF 622 selects corresponding ones of UPFs 623-625 to serve UE 601. SMF 622 indicates the network addresses for the selected ones of UPFs 623-625 to AMF 621. AMF 621 includes the network addresses in the UE context and transfers the context to UE 601 over RAN 610. UE 601 uses the UE context to establish PDU sessions over the selected ones of network slices 641-643. UE 601 exchanges user data with the corresponding ones of UPFs 623-625 over RAN 610. The corresponding ones of UPFs 623-625 exchange the user data with data network 671. NSMF 627 monitors the operating conditions of slices 641-643. Network 600 may onload and serve UEs 602 and 603 as described above with respect to UE 601.

UEs 601-603, RAN 610, the network functions of network core 620, and OAM 651 in network 600 are subscribed to NWDAF 628 for analytics reporting. AMF 621 reports metrics like processor load, memory percent occupancy, transaction rate, registration request rate, network topology data, and the like to NWDAF 628. SMF 622 reports metrics like processor load, memory percent occupancy, transaction rate, PDU session request rate, active PDU sessions, network topology data, and the like to NWDAF 628. UPFs 623-625 report metrics like processor load, memory percent occupancy, transaction rate, throughput, latency, packet loss, and the like to NWDAF 628. NSSF 626 reports metrics like processor load, memory percent occupancy, transaction rate, slice requests, NSSAI mappings, and the like to NWDAF 628. NSMF 627 reports metrics like processor load, memory percent occupancy, transaction rate, instantiated slices, slice capacity, slice bandwidth allocation, slice QoS, and the like to NWDAF 628. NEF 630 and AF 631 report metrics like processor load, memory percent occupancy, transaction rate, third-party interactions, and the like to NWDAF 628. UEs 601-603 report metrics like PDU session information, downlink data rate, received signal strength, and the like to NWDAF 628. RAN 610 reports metrics like Tracking Area Identity (TAI), radio resource information, radio frequency information, bandwidth information, amount of served UEs, and the like to NWDAF 628. OAM 651 reports metrics like network function instance amount, network resource availability, and the like to NWDAF 628.

NWDAF 628 receives and processes the metrics from UEs 601-603, RAN 610, the network functions of network core 620, and OAM 651 to generate network analytics. The analytics may comprise raw or processed data. For example, NWDAF 628 may generate metrics that comprise network averages over some time scale (e.g., hourly) for network function processor load, network function memory occupancy, latency, throughput, bandwidth utilization, transaction rate, network topology, active PDU session amount, number of served UE, slice capacity and QoS, third party interactions, RAN metrics, OAM metrics, or other types of analytics that may be derived from the information provided to NWDAF 628. UEs 601-603, RAN 610, the network functions of network core 620, and OAM 651 may report their respective metrics continuously, periodically, semi-periodically, randomly, in response to triggers, or over some other time scale. NWDAF 628 may utilize an Analytics Data Repository Function (ADRF) to store the received data and generated analytics.

Contemporaneous to the UE onloading and network analytics operations, NSCF 629 monitors network traffic patterns and network parameters to predict network changes that affect slices 641-643. Although illustrated as a stand-alone network function in network core 620, in other examples NSCF 629 may instead comprise a subcomponent of another network function in core 620 (e.g., AMF 621, NSSF 626, NSMF 627, or NEF 630) or exist as a management entity external to network core 620 (e.g., on the OAM network plane). NSCF 629 transfers API calls to the other network functions in network core 620 to retrieve KPIs for slices 641-643. For example, NSCF 629 may transfer an API call to NWDAF 628 for average slice latency, average slice bandwidth, average slice packet loss, average slice throughput, UE data, RAN data, OAM data, and the like. NSCF 629 may transfer an API call to NSMF 627 to retrieve KPIs for currently active slices, slice compositions, current slice load, current slice capacity, current slice bandwidth utilization, current slice excess bandwidth, slice QoS, authentication success rate, access control violations, security patch compliance, and the like. NSCF 629 may transfer an API call to NSSF 626 to retrieve KPIs for slice request data, served TAI by slice, and the like. NSCF 629 may transfer an API call to UPFs 623-625 to retrieve KPIs for current packet loss, current throughput, current latency, and the like. NSCF 629 may transfer an API call to SMF 622 to retrieve KPIs for PDU session information, and the like. NSCF 629 may transfer an API call to AMF 621 to retrieve KPIs for registration rate, requested slice types, and the like. In other examples, NSCF 629 may transfer API calls to different network functions and the KPIs pulled from the network functions may differ.

Although NSCF 629 is described as transferring API calls to retrieve slice KPIs to monitor traffic patterns and network related to slices 641-643, NSCF 629 may utilize other tools like packet analyzers to derive KPIs. For example, NSCF 629 may implement a Wireshark tool to monitor packet transfer through UPFs 623-625 to derive packet loss, latency, and throughput for slices 641-643. NSCF 629 may transfer API calls to retrieve non-network function data in addition to network function data that may indicate network slice performance. Although NWDAF 628 operates as a data collection entity, the data collected by NWDAF 628 is not slice specific and may not be as real time as the KPIs retrieved from the other network functions (e.g., NSMF 627). Moreover, NSCF 629 may lack communication links to UEs 601-603, RAN 610, and OAM 651 and instead relies on NWDAF 628 to collect slice KPIs generated by UEs 601-603, RAN 610, and OAM 651.

NSCF 629 hosts a machine learning model trained to predict network conditions based on the retrieved KPIs. NSCF 629 may use the machine learning model to predict/detect network congestion, security violations, malicious activity, third-party needs, and/or other network conditions that may affect slices 641-643. The machine learning model uses machine learning algorithms that are designed to recognize patterns and automatically improve through training and the use of data. Examples of machine learning algorithms include artificial neural networks, nearest neighbor methods, gradient-boosted trees, ensemble random forests, support vector machines, naïve Bayes methods, and linear regressions. The machine learning model may comprise a supervised or unsupervised model. The machine learning model comprises an input layer and an output layer, wherein complex analysis takes place between the two layers.

NSCF 629 derives feature vectors that represent the slice KPIs and inputs the feature vectors into the machine learning model. The feature vectors comprise numeric representations of the KPIs interpretable by the model. The model processes the vectors and generates an output that predicts/detects a network condition. For example, the model output may predict network congestion on slice 641, a security violation due to a denial-of-service attack on slice 642, and a third party need for slice 643. The model may also output recommendations to respond to predicted/detected network conditions. For example, the model output may recommendations to increase the available bandwidth and decrease the QoS level to respond to congestion on slice 641, to instantiate a backup slice to respond to the security violation on slice 642, and to update the access parameters for slice 643 to grant the third-party need.

NSCF 629 selects updated slice parameters based on the model output and transfers slice commands to one or more of AMF 621, SMF 622, UPFs 623-625, NSSF 626, and/or NSMF 627 to implement the updated slice parameters. For example, NSCF 629 may transfer a command to AMF 621 to increase the bandwidth utilization and reduce the QoS for slice 641, transfer a command to NSMF 627 to instantiate a backup slice for slice 642 and migrate the users to the backup slice, and transfer a command to SMF 622 to grant access for unauthorized third-party devices on UPF 625. The commanded network functions update the slice parameters for slices 641-643 as directed by NSCF 629 and slices 641-643 exchange user data with UEs 601-603 over RAN 610 using the updated parameters.

In examples where NSCF 629 determines to instantiate a new network slice, the commanded network function (e.g., NSMF 627) may interface with OAM 651 to create the new slice. For example, NSMF 627 may receive a command to create a backup slice for slice 641 from NSCF 629. NSMF 627 may transfer a request to OAM 651 to create a new network slice that comprises the same or substantially similar service characteristics as slice 641. OAM 651 may receive the request and in response, organize the commuting resources of network core 620 to instantiate a new UPF to create the backup slice for slice 641.

Although the above example generally relates to NSCF 629 transferring API calls to retrieve slice KPIs, in some examples, NSCF 629 instead receives an API call that drives NSCF 629 to modify parameters for slices 641-643. In particular, NSCF 629 may receive API calls generated by third-party AS 661 to modify a network slice to support a third-party need. For example, AS 661 may transfer an API call to NEF 630 over AF 631 that includes some type of third-party requirement that is not currently being met by a network slice. Exemplary third-party requirements include updated access authorizations, updated bandwidth allocation, updated slice QoS, and the like. NEF 630 may expose the API call to NSCF 629 which may then decide to grant the third-party requirement before official approval from network operators. NSCF 629 may determine to grant third-party requests based on the third-party type. For example, NSCF 629 may grant requests to well-established or otherwise known third-parties (e.g., by whitelisting) and block third-party requests from unknown third-parties. Once granted, NSCF 629 selects updated slice parameters based on the third-party needs (e.g., updated access policies, update bandwidth utilization, updated QoS, etc.) and directs the appropriate network functions in network core 620 to implement the updated parameters. In doing so, network 600 responds to third-party needs without requiring the third-party to update its service agreement with network core 620. By not requiring the third-party to update its service agreement, network 600 more quickly meets third-party needs.

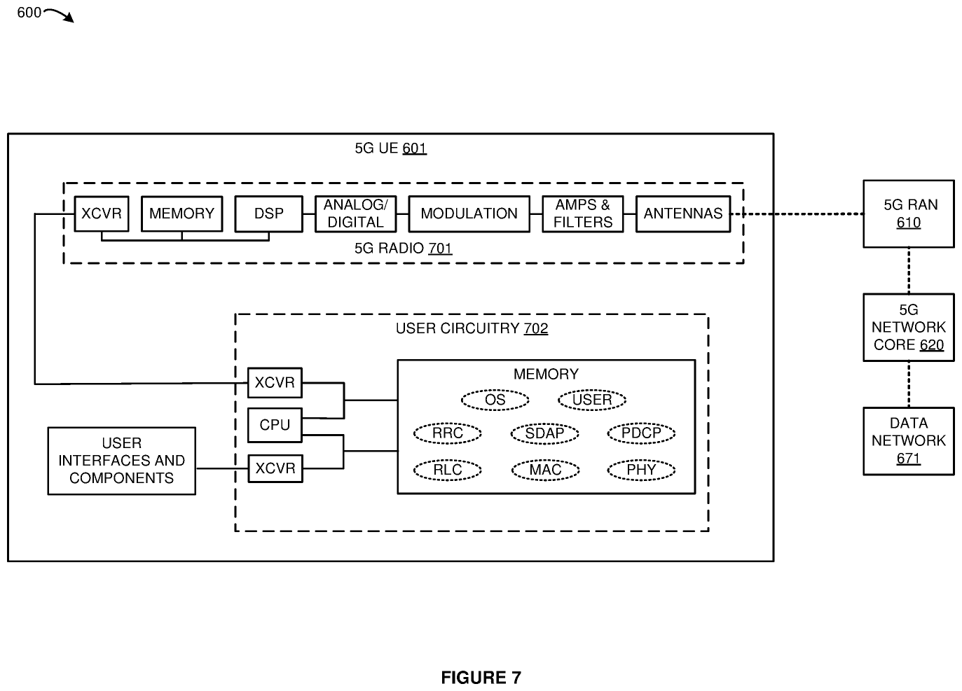

FIG. 7 illustrates 5G UE 601 in 5G communication network 600. UE 601 comprises an example of user device 101 and UE 301, although user device 101 and UE 301 may differ. UEs 602 and 603 comprise a similar architecture to UE 601. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER) and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

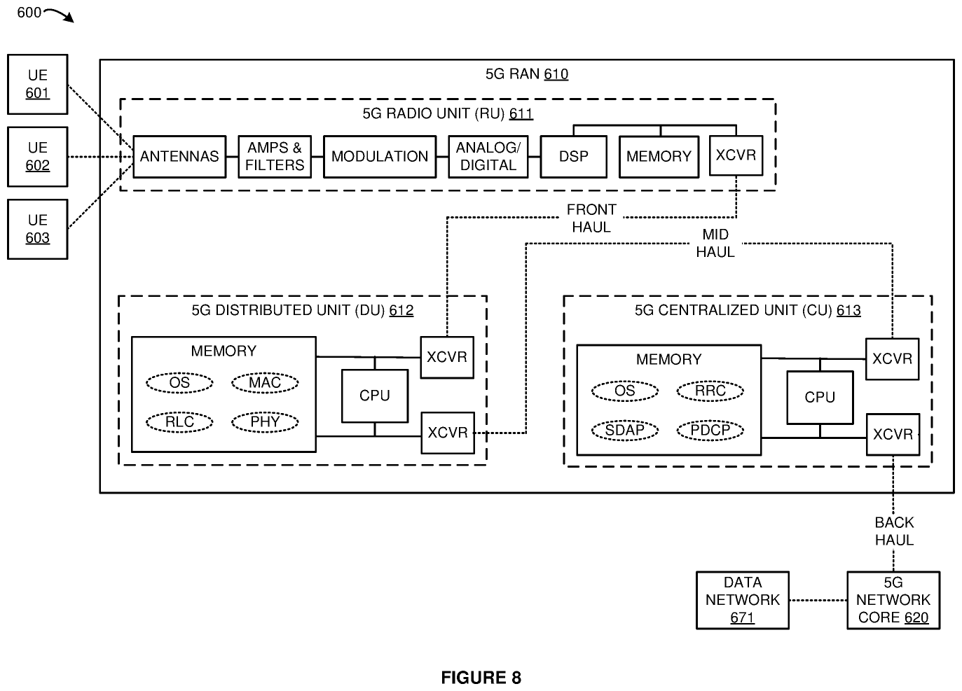

FIG. 8 illustrates 5G RU 611, 5G DU 612, and 5G CU 613 in 5G communication network 600. RU 611, DU 612, and CU 613 comprise an example of the access network 111 and RAN 311, although access network 111 and RAN 311 may differ. RU 611 comprises antennas, amplifiers, filters, modulation, analog-to-digital interfaces, DSP, memory, and transceivers (XCVRs) that are coupled over bus circuitry. UEs 601-603 are wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UEs 601-603 and to exchange 5GNR data with DU 612.

For the uplink, the antennas receive wireless signals from UEs 601-603 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UEs 601-603 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

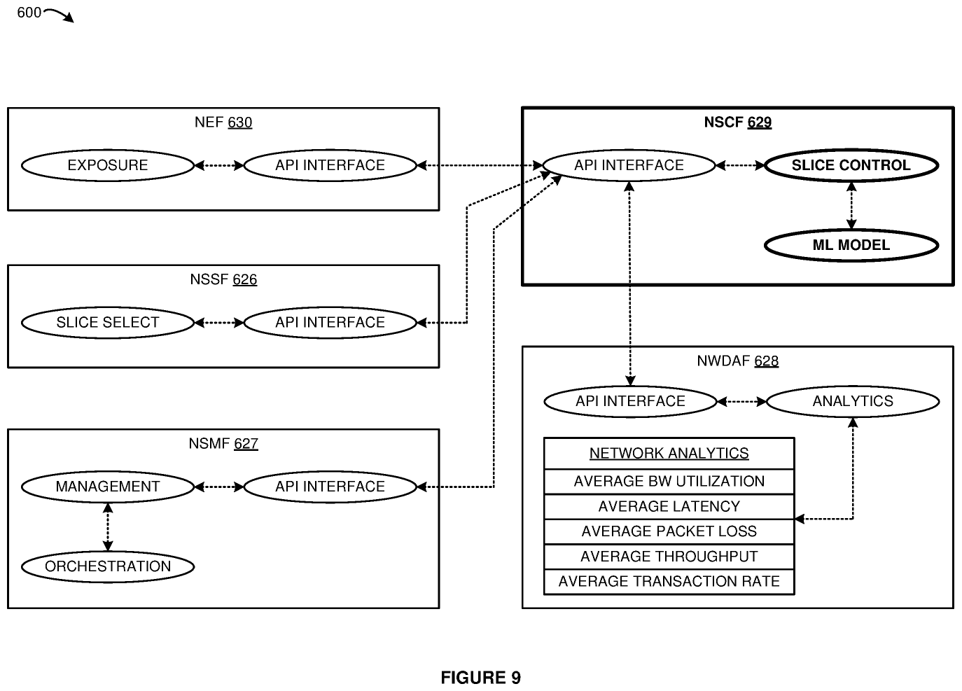

FIG. 9 illustrates NSSF 626, NSMF 627, NWDAF 628, NSCF 629, and NEF 630 in 5G communication network 600. NSSF 626 comprises modules for slice selection and API interfacing. The slice selection module maps requested NSSAI to allow NSSAI to identify network slices for a requesting UE. NSMF 627 comprises modules for slice management, slice orchestration, and API interfacing. The slice management model manages the resources allocated to slices 641-643. The slice orchestration module handles network slice instantiation and governs the RAN resources and network functions allocated to an instantiated slice. NWDAF 628 stores a network analytics table and comprises modules for network analytics and API interfacing. The analytics module process metrics received from subscribing network functions in core 620 to generate network analytics data. As illustrated in FIG. 9, the network analytics data includes average bandwidth utilization, average latency, average packet loss, average throughput, and average transaction rate. It should be appreciated that this table is exemplary and may store additional or different information in other examples. NSCF 629 hosts a machine learning (ML) model and comprises modules for slice control and API interfacing. The machine learning model generates predictions and recommendations based on slice KPIs retrieved from other functions in network core 620. The slice control model generates updated slice parameters based on the output from the machine learning model and drives corresponding network functions (e.g., NSMF 627) to implement the updated slice parameters. NEF 630 comprises modules for event exposure and API interfacing. The event exposure module exposes network events and third-party requests to the other functions resident in core 620. For example, NEF 630 may receive a third-party request for increased QoS on slice 643 from AS 661 and the exposure module may expose this request to NSCF 629. The API interfacing modules allow NSSF 626, NSMF 627, NWDAF 628, NSCF 629, and NEF 630 to exchange signaling with each other, with the other network functions in 5G core 620, and with external systems like 5G RAN 610, OAM 651, and third-party AS 661.

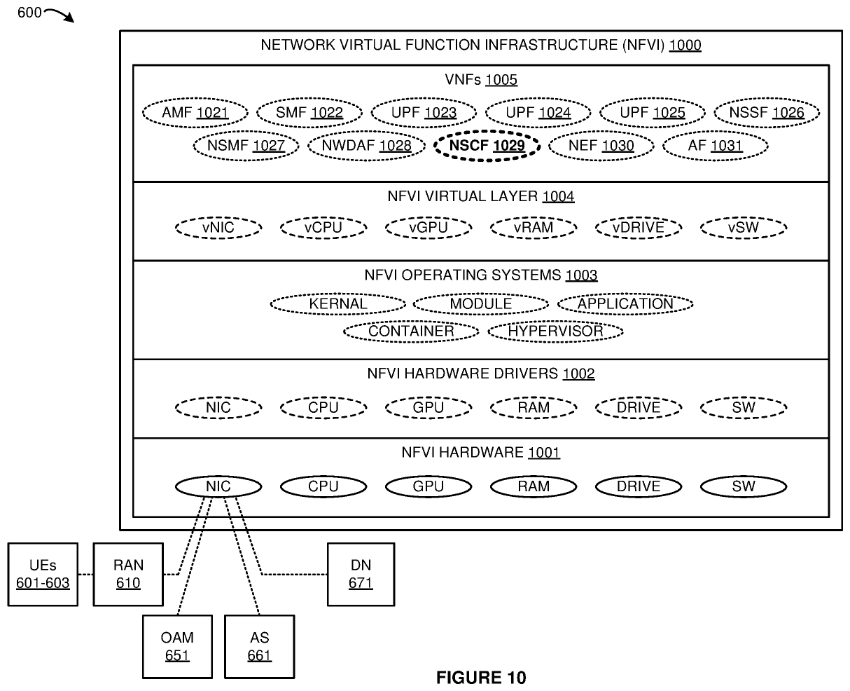

FIG. 10 illustrates Network Function Virtualization Infrastructure (NFVI) 1000. NFVI 1000 comprises an example of core network 121 illustrated in FIG. 1 and network circuitry 320 illustrated in FIG. 3, although core network 121 and network circuitry 320 may differ. NFVI 1000 comprises NFVI hardware 1001, NFVI hardware drivers 1002, NFVI operating systems 1004, NFVI virtual layer 1004, and NFVI Virtual Network Functions (VNFs) 1005. NFVI hardware 1001 comprises Network Interface Cards (NICs), CPU, GPU, RAM, Flash/Disk Drives (DRIVE), and Data Switches (SW). NFVI hardware drivers 1002 comprise software that is resident in the NIC, CPU, GPU, RAM, DRIVE, and SW. NFVI operating systems 1004 comprise kernels, modules, applications, containers, hypervisors, and the like. NFVI virtual layer 1004 comprises vNIC, vCPU, vGPU, vRAM, vDRIVE, and vSW. NFVI VNFs 1005 comprise AMF 1021, SMF 1022, UPFs 1023-1025, NSSF 1026, NSMF 1027, NWDAF 1028, NSCF 1029, NEF 1030, and AF 1031. Additional VNFs and network elements like AUSF, PCF, UDM, and NRF are typically present but are omitted for clarity. NFVI 1000 may be located at a single site or be distributed across multiple geographic locations. The NIC in NFVI hardware 1001 is coupled to RAN 610, OAM 651, AS 661, and data network (DN) 671. NFVI hardware 1001 executes NFVI hardware drivers 1002, NFVI operating systems 1004, NFVI virtual layer 1004, and NFVI VNFs 1005 to form AMF 621, SMF 622, UPFs 623-625, NSSF 626, NSMF 627, NWDAF 628, NSCF 629, NEF 630, and AF 631.

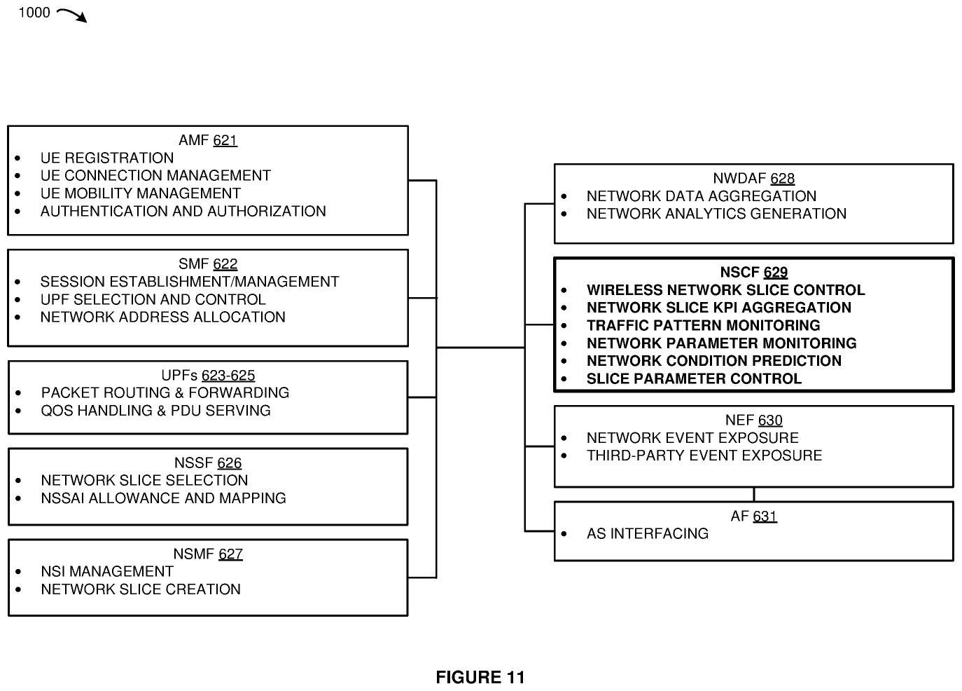

FIG. 11 further illustrates NFVI 1000 in 5G communication network 600. AMF 621 comprises capabilities for UE registration, UE connection management, UE mobility management, authentication, and authorization. SMF 622 comprises capabilities for session establishment, session management, UPF selection, UPF control, and network address allocation. UPFs 623-625 comprise capabilities for packet routing, packet forwarding, QoS handling, and PDU serving. NSSF 626 comprises capabilities for network slice selection, NSSAI allowance, and NSSAI mapping. NSMF 627 comprises capabilities for Network Slice Instance (NSI) management and network slice creation. NWDAF 628 comprises capabilities for network data aggregation and network analytics generation. NSCF 629 comprises capabilities for wireless network slice control, network slice KPI aggregation, traffic pattern monitoring, network parameter monitoring, network condition prediction, and slice parameter control. NEF 630 comprises capabilities for network event exposure and third-party event exposure. AF 631 comprises capabilities for AS interfacing.

In the following example, slice 641 comprises a primary URLLC slice and slice 642 comprises a backup URLLC slice bonded to slice 641. In some examples, AMF 621 receives registration requests from UEs 601-603 over RAN 610. The registration requests comprise a registration type, UE capabilities, NSSAI requests, and PDU session requests. In response to the registration request, AMF 621 transfers an identity request to UEs 601-603 over RAN 610 and in response, receives SUCIs for UEs 601-603. AMF 621 interacts with other network functions to authenticate the identities of UEs 601-603. Responsive to the authentication, AMF 621 registers UEs 601-603 and retrieves respective subscriber data for UEs 601-603 to form UE context. The UE contexts comprise QoS metrics, allowed NSSAI, service attributes, and service authorizations for UEs 601-603.

Once the context is generated AMF 621, AMF 621 interfaces with NSSF 626 to select network slices for UEs 601-603. NSSF 626 correlates the requested NSSAI from UEs 601-603 to URLLC slice 641. NSSF 626 returns the slice Identifier (ID) to AMF 621 which then selects slice 641. AMF 621 selects SMF 622 to serve UEs 601-603 based on the slice ID, QoS metrics, PDU sessions, and service attributes. AMF 621 directs SMF 622 to establish PDU sessions for UEs 601-603 over URLLC slice 641-643 to SMF 622. SMF 622 directs UPFs 623 to serve UE 601 based on the slice ID for slice 641 and indicates the network address for UPF 623 to AMF 621. AMF 621 includes the network address for UPF 623 in the UE context and transfers the context to UE 601 over RAN 610. Subsequently, UEs 601-603 begin their respective PDU sessions. UPF 623 exchanges low-latency PDU session data generated by UEs 601-603 over RAN 610. UPF 623 exchanges the low-latency PDU session data with data network 671. NSMF 627 monitors the operating conditions of slices 641 to track slice capacity, slice latency, and slice throughput. Contemporaneous to the UE onloading, slice selection, and service operations, UEs 601-603, RAN 610, the network functions in network core 620, and OAM 651 report operating metrics to NWDAF 628. NWDAF 628 receives and processes the metrics to generate network analytics data.

NSCF 629 monitors network traffic patterns and network parameters to predict network changes that affect slices 641-643. NSCF 629 transfers an API call to NWDAF 628 for average slice latency, average slice bandwidth, average slice packet loss, average slice throughput, UE data, RAN data, and OAM data. NSCF 629 transfers an API call to NSMF 627 to retrieve KPIs for currently active slices, slice compositions, current slice load, current slice capacity, current slice bandwidth utilization, current slice excess bandwidth, and slice QoS. NSCF 629 transfers an API call to NSSF 626 to retrieve KPIs for slice request data and served TAI by slice. NSCF 629 transfers API calls to UPFs 623-625 to retrieve KPIs for current packet loss, current throughput, and current latency. NSCF 629 transfers an API call to SMF 622 to retrieve KPIs for active PDU session types and number. NSCF 629 transfers an API call to AMF 621 to retrieve KPIs for registration rate and requested slice types.

NSCF 629 receives API responses comprising the requested KPIs and generates feature vectors to numerically represent the slice KPIs. NSCF 629 inputs the feature vectors into its resident machine learning model which outputs a network congestion prediction. In this example, the model predicts network congestion will impact slice 641 based on current slice load and an increase in registration requests that include the NSSAI for slice 641. NSCF 629 determines the excess bandwidth available to slice 641 is insufficient to support the predicted load on slice 641. For example, NSCF 629 may correlate the predicted load to a required bandwidth and determines the required bandwidth exceeds the available bandwidth for slice 641.

NSCF 629 generates slice commands for NSMF 627 and AMF 621 to respond to the predicted network congestion. The command for NSMF 627 directs NSMF 627 to activate slice 642. The command for AMF 621 directs AMF 621 to migrate 50% of users from slice 641 to slice 642 and to load balance additional registration requests for a URLLC slice between the two slices. As stated above, slice 642 comprises a backup URLLC slice bonded to slice 641. By maintaining an active standby slice for slice 641, network 600 may offload users to the backup slice to maintain the user experience (e.g., maintain latency and QoS) without having to instantiate additional network resources. By not having to instantiate a new slice, network 600 is able to more quickly offload users to respond to excess slice loading thereby decreasing the response time to predicted/detected network congestion. Although this example is directed to bonding two URLLC slices, a variety of slice types may be bonded. For example, NSCF 629 may bond an N1 interface Non-Access Stratum (NAS) messaging slice to an N3 interface data slice.

NSCF 629 transfers the slice commands to NSMF 627 and AMF 621. NSMF 627 receives the command and activates slice 642. NSMF 627 notifies AMF 621 of the slice activation. AMF 621 receives the command and notifies SMF 622 of the migration. SMF 622 returns the network address for UPF 624 to AMF 621. AMF 621 selects half of the UEs active on slice 641 and transfers a PDU session update command to the selected users over RAN 610. AMF 621 may select the users randomly or may use a metric like device type or International Mobile Subscriber Identity (IMSI) range to select the users. The command directs the UEs to migrate to slice 642 and includes the network address for UPF 624. Subsequently, the migrated UEs switch over to slice 642. UPF 624 exchanges low-latency PDU session data generated by the migrated UEs over RAN 610. UPF 623 exchanges low-latency PDU session data generated by the non-migrated UEs over RAN 610. UPFs 623 and 624 exchange the low-latency PDU session data with data network 671. AMF 621 load balances slices selections between slices 641 and 642 for future requests for URLLC slices.

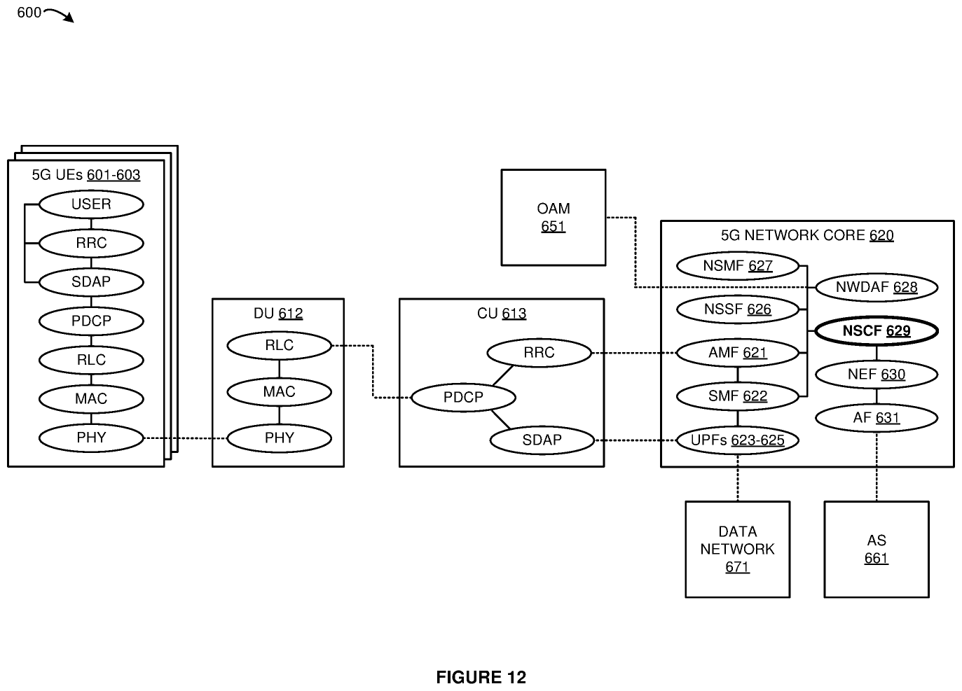

FIG. 12 illustrates an exemplary operation of 5G communication network 600 to dynamically manage network slices. The operation may vary in other examples. In the following example, slice 641 comprises an eMBB slice and slice 643 comprises a security slice for slice 641. In some examples, UE 601 attaches to RAN 610. The RRC in UE 601 transfers a registration request to the RRC in CU 613 over the PDCPs, RLCs, MACs, and PHYs. The registration request comprises a registration type, UE capabilities, NSSAI requests, PDU session requests, and the like. In response to the registration request, AMF 621 interacts with other network functions and UE 601 to authenticate UE 601. Responsive to the authentication, AMF 621 registers UE 601 for service on network 600. AMF 621 generates UE context for UE 601 that comprises QoS metrics, allowed NSSAI, service attributes, and service authorizations for UE 601. AMF 621 interfaces with NSSF 626 to a select network slice for UE 601. NSSF 626 maps the NSSAI requested by to eMBB slice 641 and indicates the slice ID for eMBB slice 641 to AMF 621. In response, AMF 621 selects eMBB slice 641 for UE 601. AMF 621 directs SMF 622 to serve UE 601 over slice 641. SMF 622 indicates the network address for UPF 623 to AMF 621 and controls UPF 623 to serve UE 601. AMF 621 includes the network address in the UE context and transfers the context to the RRC in CU 613. The RRC in CU 613 transfers the UE context to UE 601 over the PDCPs, RLCs, MACs, and PHYs. The RRC in UE 601 directs the SDAP in UE 601 to begin the PDU session. The SDAP exchanges eMBB user data generated by an eMBB user application in UE 601 with the SDAP in CU 613 over the PDCPs, RLCs, MACs, and PHYs. The SDAP in UE 613 addresses the data for UPF 623 based on the UE context to route the data to slice 641. The SDAP in CU 613 exchanges the eMBB user data with UPF 623. UPF 623 exchanges the eMBB user data with data network 671.

NSCF 629 monitors network traffic patterns and network parameters to predict network changes that affect slices 641-643. NSCF 629 transfers an API call to NWDAF 628 to retrieve KPIs for average slice latency, average slice bandwidth, average slice packet loss, and average slice throughput. NSCF 629 transfers an API call to NSMF 627 to retrieve KPIs for currently active slices, slice compositions, current slice load, current slice capacity, current slice bandwidth utilization, current slice excess bandwidth, and slice QoS. NSCF 629 transfers an API call to NSSF 626 to retrieve KPIs for slice request data and served TAI. NSSF 626, NSMF 627, and NWDAF 628 transfer API responses to network core 620 comprising the requested information.

NSCF 629 converts the KPIs and into feature vectors inputs the KPIs into its resident machine learning model trained to predict/detect network conditions. The machine learning model generates an output that detects a security violation on eMBB slice 641. It should be appreciated that when network slices become overburdened (e.g., too many active PDU sessions), the security capabilities of the slice may degrade allowing malicious actors to exploit the vulnerability. NSCF 629 determines to instantiate a security slice to migrate the UEs on eMBB slice 641 to stop further exploitation of the security violation and to diagnose the cause of the security violation. The security slice may comprise a functional slice (e.g., eMBB slice) with increased capacity to prevent further security violations. Alternatively, the security slice may comprise a null or dummy slice (e.g., a honey slice) to park malicious actors on. The null slice could route to a false endpoint with synthetic network/user data to attract malicious actors. By attracting malicious actors to a null slice, network 600 inhibits further security breaches and increases the amount of time for network operators and/or network functions to identify and blacklist the malicious actors.

NSCF 629 generates slice commands for NSMF 627 and AMF 621 to respond to the detected security violation. The command directs NSMF 627 to activate security slice 643 and to diagnose the security violation. The command directs AMF 621 to migrate all UEs on slice 641 to slice 643. NSCF 629 transfers the slice commands to NSMF 627 and AMF 621. NSMF 627 receives the command and activates slice 643. NSMF 627 notifies AMF 621 of the slice activation. AMF 621 receives the command and directs SMF 622 to migrate UEs from slice 641 to slice 643. SMF 622 returns the network address for UPF 625 to AMF 621 and AMF 621 transfers PDU session update commands for UEs attached to slice 641 to the RRC in CU 613. The RRC in CU 613 transfers the session update commands to the UEs, including to the RRC in UE 601 over the PDCPs, RLCs, MACs, and PHYs. The RRC in UE 601 receives the command and directs the SDAP to begin routing eMBB data to UPF 625. Subsequently, the SDAP in UE 601 exchanges eMBB data with the SDAP in CU 613. The SDAP in CU 613 exchanges the eMBB user data with UPF 625. UPF 625 exchanges the eMBB data with data network 671.

AMF 621 notifies NSMF 627 that the UE migration is complete. NSMF 627 accesses activity logs for slice 641 to characterize the security violation. For example, NSMF 627 may determine what type of security violation occurred, when the violation occurred, the type of attack, the UE that caused the security violation, and the like. NSMF 627 reports its findings to OAM 651. OAM 651 may then take appropriate action to respond to the security violation. For example, OAM 651 may blacklist the UEs which exploited the security vulnerability.

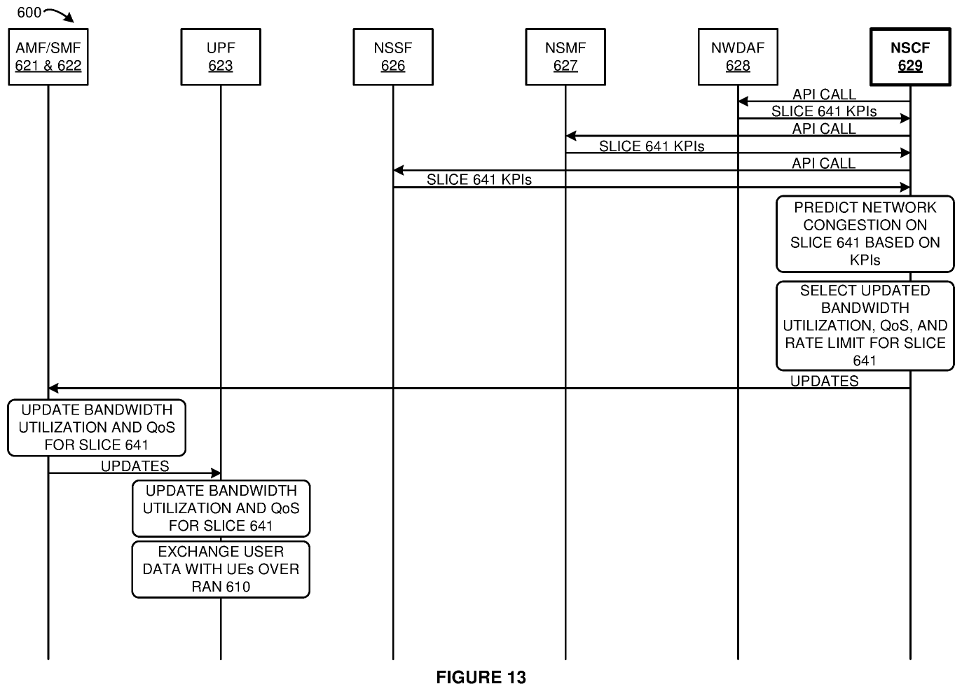

FIG. 13 illustrates an exemplary operation of 5G communication network 600 to dynamically manage network slices. The operation may vary in other examples. In some examples, NSCF 629 transfers API calls to NWDAF 628, NSMF 627, and NSSF 627 to retrieve KPIs that describe traffic patterns and network parameters related to slice 641. NWDAF 628, NSMF 627, and NSSF 626 transfer API responses to NSCF 629 that comprise the requested KPIs. For example, NWDAF 628 may transfer KPIs that describe average latency, throughput, and bandwidth utilization for slice 641, NSMF 627 may transfer KPIs that describe near realtime latency, throughput, and bandwidth utilization for slice 641, and NSSF 626 may transfer KPIs that describe slice selection rate for slice 641. NSCF 629 inputs the retrieved KPIs into its machine learning model to generate a machine learning output. In this example, the output predicts future network congestion on slice 641. For example, NSCF 629 may detect below average latency, above average throughput and bandwidth utilization, and an uptick in requests for slice 641 to predict imminent network congestion. NSCF 629 decides to grant additional bandwidth and reduce the QoS of slice 641 to preemptively respond to the predicted network congestion. NSCF 629 selects updated bandwidth and QoS values for slice 641 and transfers the updated slice parameters to AMF 621 and SMF 622 to modify slice 641. AMF 621 interfaces with RAN 610 and SMF 622 to increase the available bandwidth for slice 641 based on the direction from NSCF 629. SMF 622 interfaces with UPF 623 to decrease the QoS for slice 641 based on the direction from NSCF 629. UPF 623 exchanges user data with UEs on slice 641 over RAN 610.

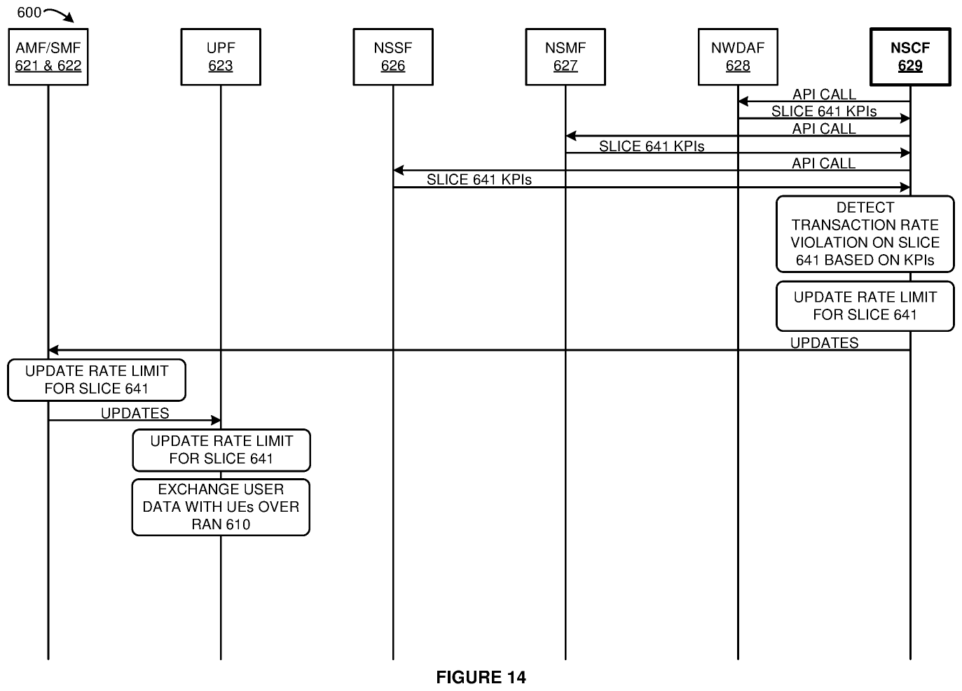

FIG. 14 illustrates an exemplary operation of 5G communication network 600 to dynamically manage network slices. The operation may vary in other examples. In some examples, NSCF 629 transfers API calls to NWDAF 628, NSMF 627, and NSSF 627 to retrieve KPIs that describe traffic patterns and network parameters related to slice 641. NWDAF 628, NSMF 627, and NSSF 626 transfer API responses to NSCF 629 that comprise the requested KPIs. For example, NWDAF 628 may transfer KPIs that describe average transaction rate for slice 641, NSMF 627 may transfer KPIs that describe near realtime transaction rate for slice 641, and NSSF 626 may transfer KPIs that describe slice selection rate for slice 641. NSCF 629 inputs the retrieved KPIs into its machine learning model to generate a machine learning output. In this example, the output detects a transaction rate violation for slice 641. Transaction rate describes the frequency of requests received by a network function. For example, NSCF 629 may detect that the transaction rate for the network functions that compose slice 641 exceed historical transaction rates on slice 641 by a threshold value to detect the transaction rate violation. NSCF 629 decides to increase the transaction rate limit on slice 641 to account for the uptick in traffic. In other examples, NSCF 629 may instead decide to rate limit slice 641 to block excessive requests on the slice. NSCF 629 selects an updated transaction rate for slice 641 and transfers the updated transaction rate to AMF 621 and SMF 622 to modify slice 641. AMF 621, SMF 622, and UPF 623 interface to increase the allowed transaction rate for slice 641 based on the direction from NSCF 629. UPF 623 exchanges user data with UEs on slice 641 over RAN 610.

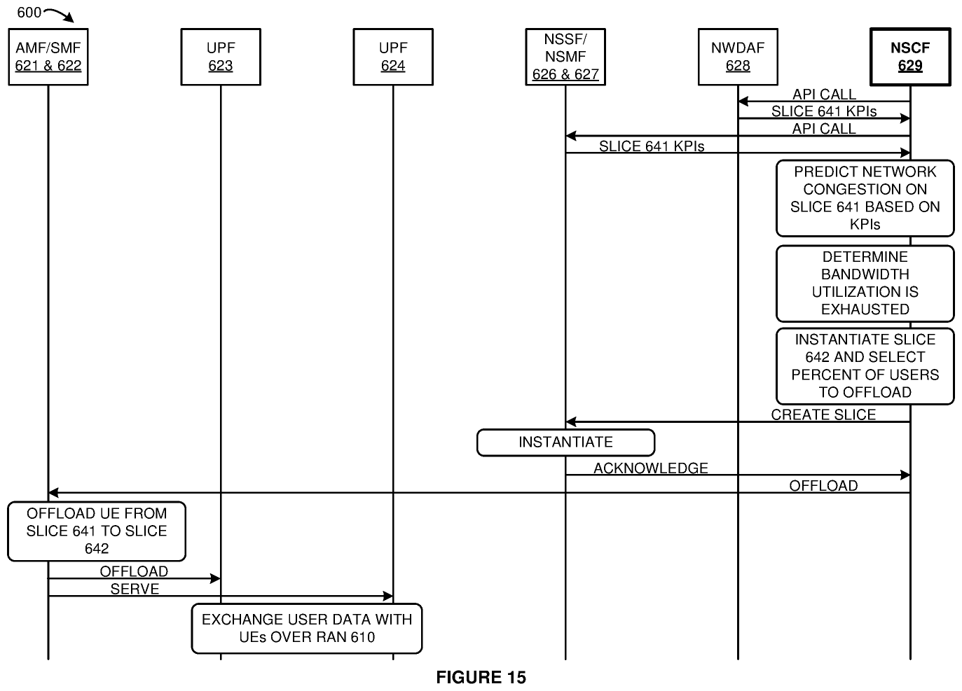

FIG. 15 illustrates an exemplary operation of 5G communication network 600 to dynamically manage network slices. The operation may vary in other examples. In some examples, NSCF 629 transfers API calls to NWDAF 628, NSMF 627, and NSSF 627 to retrieve KPIs that describe traffic patterns and network parameters related to slice 641. NWDAF 628, NSMF 627, and NSSF 626 transfer API responses to NSCF 629 that comprise the requested KPIs that describe latency, throughput, packet loss, and bandwidth utilization for slice 641. NSCF 629 inputs the retrieved KPIs into its machine learning model to generate a machine learning output. In this example, the output predicts future network congestion on slice 641. For example, NSCF 629 may detect an increase in packet loss and an uptick in requests for slice 641 to predict imminent network congestion. NSCF 629 correlates the predicted amount of network congestion to a bandwidth amount to serve the predicted influx of users on slice 641 at the current QoS level of slice 641. NSCF 629 compares the required bandwidth amount to the current bandwidth utilization of slice 641 and the amount of available excess bandwidth for slice 641. NSCF 629 determines the excess bandwidth available to slice 641 is insufficient to serve the predicted uptick in traffic based on the comparison. In response, NSCF 629 decides to instantiate and bond slice 642 to slice 641. NSCF 629 selects a percentage of users on slice 641 to offload to the newly instantiated slice. NSCF 629 transfers an instantiation command to NSMF 627 to create slice 642 that is bonded to slice 641. For example, slice 641 may comprise a MIoT slice and the instantiate command may direct NSMF 627 to create and bond a new MIoT slice to slice 641. NSMF 627 receives the command and interfaces with OAM 651 to spin up UPF 624 to create slice 642. NSMF 627 acknowledges the instantiation to NSCF 629. NSCF 629 transfers an offload command to AMF 621 and SMF 622 to migrate a percentage of users from slice 641 to slice 642. AMF 621, SMF 622, and UPF 623 interface to move the percentage of users to slice 642. Once migrated, SMF 622 directs UPF 624 to serve the migrated users over RAN 610. UPF 623 exchanges user data with non-migrated UEs on slice 641 over RAN 610. UPF 624 exchanges user data with migrated UEs on slice 642 over RAN 610. AMF 621 load balances future slice selections between the two bonded slices.

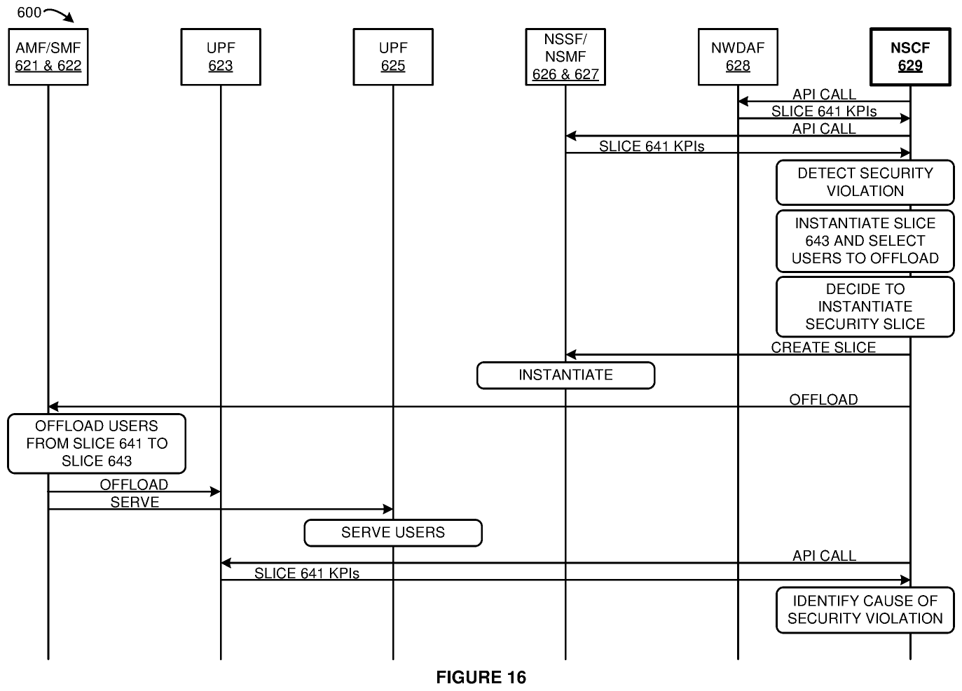

FIG. 16 illustrates an exemplary operation of 5G communication network 600 to dynamically manage network slices. The operation may vary in other examples. In some examples, NSCF 629 transfers API calls to NWDAF 628, NSMF 627, and NSSF 627 to retrieve KPIs that describe traffic patterns and network parameters related to slice 641. NWDAF 628, NSMF 627, and NSSF 626 transfer API responses to NSCF 629 that comprise the requested KPIs that describe latency, throughput, packet loss, and bandwidth utilization for slice 641. NSCF 629 inputs the retrieved KPIs into its machine learning model to generate a machine learning output. In this example, the output predicts a security violation on slice 641. For example, NSCF 629 may detect that otherwise non-accessible network resources are being accessed by users over slice 641. In response, NSCF 629 decides to instantiate and bond a security slice (slice 643) to slice 641. NSCF 629 transfers an instantiation command to NSMF 627 to create security slice 643 that is bonded to slice 641. For example, slice 641 may comprise an eMBB slice and the instantiate command may direct NSMF 627 to create and bond a new eMBB slice with enhanced capacity and security features to slice 641. For example, the enhanced security parameters may comprise a more advanced authentication procedure, an increased security patch compliance percent, and the like. NSMF 627 receives the command and interfaces with OAM 651 to spin up UPF 625 to create slice 643. NSMF 627 acknowledges the instantiation to NSCF 629. NSCF 629 transfers an offload command to AMF 621 and SMF 622 to migrate all users from slice 641 to slice 643. AMF 621, SMF 622, and UPF 623 interface to move the users to slice 643. SMF 622 directs UPF 625 to serve the migrated users over RAN 610. Once migrated, NSCF 629 interrogates slice 641 by transferring an API call to UPF 623 for slice KPIs to identify the cause of the security violation. UPF 623 returns the requested KPIs to NSCF 629 which processes the KPIs to identify the cause of the security violation. In particular, NSCF 629 may determine which UEs exploited the security fault in slice 641 and whether the exploitation was malicious (e.g., intentional by the UEs) or accidental (e.g., from a defect in slice 641).

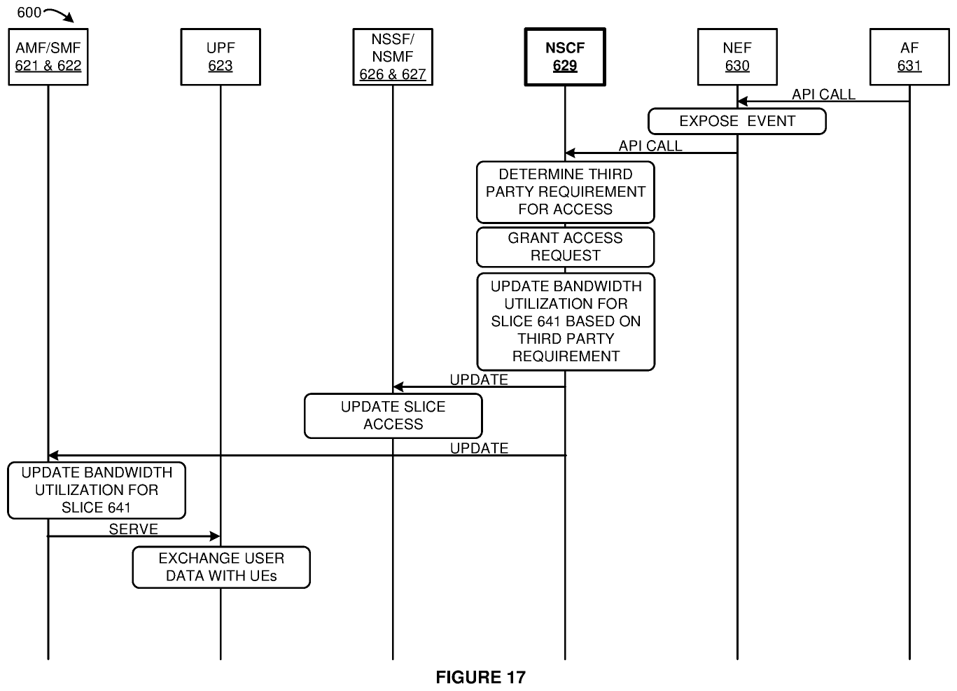

FIG. 17 illustrates an exemplary operation of 5G communication network 600 to dynamically manage network slices. The operation may vary in other examples. In some examples, AF 631 receives an API call from third-party AS 661. The API call requests access updates for slice 641 for devices associated with AS 661 that are not currently authorized for service on slice 641. The API call may identify the devices by IMSI or some other type of unique identifier. AF 631 forwards the API call to NEF 630 which determines to expose the event to NSCF 629 and transfers the API call to NSCF 629. NSCF 629 processes the API call to determine the third-party requirement for AS 661. NSCF 629 decides to proactively allow the third-party request and grant access to the unauthorized devices. Based on the number of new devices to be allowed on slice 641, NSCF 629 updates the bandwidth utilization on slice 641 to maintain the QoS for slice 641 in response to the influx of new devices. NSCF 629 transfers access update commands to NSSF 626 and NSMF 627 that direct NSSF 626 and NSMF 627 to allow the new devices on slice 641. NSSF 626 and NSMF 627 update the slice policies to allow the new devices on slice 641. NSCF 629 transfers a bandwidth utilization command to AMF 621 and SMF 622 to increase the bandwidth allocation for slice 641. AMF 621 interfaces with RAN 610 and SMF 622 to increase the available bandwidth for slice 641 based on the direction from NSCF 629. SMF 622 interfaces with UPF 623 to serve the new devices based on the direction from NSCF 629. UPF 623 exchanges user data with UEs on slice 641 over RAN 610.

The wireless data network circuitry described above comprises computer hardware and software that form special-purpose network circuitry to dynamically manage network slices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to dynamically manage network slices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless communication network to dynamically manage network slices, the method comprising:
retrieving network slice Key Performance Indicators (KPIs) that indicate traffic patterns and network parameters related to a wireless network slice;
generating a prediction of network conditions for the wireless network slice based on the network slice KPIs;
updating one or more network slice parameters for the wireless network slice based on the prediction; and
modifying the wireless network slice based on the one or more updated network slice parameters.

2. The method of claim 1 wherein retrieving the network slice KPIs comprises:
transferring an Application Programming Interface (API) call to a Network Data Analytics Function (NWDAF) that stores analytics data generated by control plane network functions, user plane network functions, and user devices;
receiving an API response from the NWDAF that comprise the network slice KPIs.

3. The method of claim 1 wherein retrieving the network slice KPIs comprises:
transferring an Application Programming Interface (API) call to a Network Slice Selection Function (NSSF) that stores slice data for the wireless network slice;
receiving an API response from the NSSF that comprise the network slice KPIs.

4. The method of claim 1 wherein retrieving the network slice KPIs comprises:
transferring an Application Programming Interface (API) call to a Network Slice Management Function (NSMF) that stores slice management data for the wireless network slice;
receiving an API response from the NSMF that comprise the network slice KPIs.

5. The method of claim 1 further comprising:
receiving an Application Programming Interface (API) call from a Network Exposure Function (NEF) that comprises a third-party requirement for the wireless network slice; and wherein:
updating the one or more network slice parameters comprises updating the one or more network slice parameters for the wireless network slice based on the third-party requirement; and further comprising:
modifying the wireless network slice based on the one or more updated network slice parameters to meet the third-party requirement.

6. The method of claim 1 wherein:
the network slice KPIs comprise at least one of bandwidth utilization, latency, packet loss, transaction rate, or throughput for the wireless network slice; and
the predicted network conditions comprise one or more of network congestion or a security violation for the wireless network slice.

7. The method of claim 1 wherein:
updating the one or more network slice parameters for the wireless network slice based on the prediction comprises updating one or more of a bandwidth utilization, a Quality-of-Service (QoS), or a security parameter for the wireless network slice; and
modifying the wireless network slice based on the one or more updated network slice parameters comprises modifying the wireless network slice using one or more of the updated bandwidth utilization, the updated QoS, or the updated security parameter.

8. The method of claim 1 further comprising:
determining the predicted network conditions persist after modifying the wireless network slice based on the one or more updated network slice parameters;
instantiating a new wireless network slice based on the wireless network slice; and
transferring at least a portion of the users from the wireless network slice to the new wireless network slice.

9. The method of claim 1 wherein:
generating the prediction of the network conditions for the wireless network slice comprises feeding the network slice KPIs into a machine learning model trained to predict the network conditions based on the network slice KPIs and receiving a machine learning output that comprises the prediction.

10. A wireless communication network to dynamically manage network slices, the wireless communication network comprising:
A Network Slice Control Function (NSCF) configured to:
retrieve network slice Key Performance Indicators (KPIs) that indicate traffic patterns and network parameters related to a wireless network slice;
generate a prediction of network conditions for the wireless network slice based on the network slice KPIs;
update one or more network slice parameters for the wireless network slice based on the prediction; and
modify the wireless network slice based on the one or more updated network slice parameters.

11. The wireless communication network of claim 10 wherein the NSCF is configured to:
transfer an Application Programming Interface (API) call to a Network Data Analytics Function (NWDAF) that stores analytics data generated by control plane network functions, user plane network functions, and user devices;
receive an API response from the NWDAF that comprise the network slice KPIs.

12. The wireless communication network of claim 10 wherein the NSCF is configured to:
transfer an Application Programming Interface (API) call to a Network Slice Selection Function (NSSF) that stores slice data for the wireless network slice;
receive an API response from the NSSF that comprise the network slice KPIs.

13. The wireless communication network of claim 10 wherein the NSCF is configured to:
transfer an Application Programming Interface (API) call to a Network Slice Management Function (NSMF) that stores slice management data for the wireless network slice;
receive an API response from the NSMF that comprise the network slice KPIs.

14. The wireless communication network of claim 10 wherein the NSCF is configured to:
receive an Application Programming Interface (API) call from a Network Exposure Function (NEF) that comprises a third-party requirement for the wireless network slice;
update the one or more network slice parameters for the wireless network slice based on the third-party requirement; and
modify the wireless network slice based on the one or more updated network slice parameters to meet the third-party requirement.

15. The wireless communication network of claim 10 wherein:
the network slice KPIs comprise at least one of bandwidth utilization, latency, packet loss, transaction rate, or throughput for the wireless network slice; and
the predicted network conditions comprise one or more of network congestion or a security violation for the wireless network slice.

16. The wireless communication network of claim 10 wherein the NSCF is configured to:
update one or more of a bandwidth utilization, a Quality-of-Service (QoS), or a security parameter for the wireless network slice to update the one or more network slice parameters; and
modify the wireless network slice using one or more of the updated bandwidth utilization, updated QoS, or updated security parameters.

17. The wireless communication network of claim 10 the NSCF is further configured to:
determine the predicted network conditions persist after modifying the wireless network slice based on the one or more updated network slice parameters;
instantiate a new wireless network slice based on the wireless network slice; and
transfer at least a portion of the users from the wireless network slice to the new wireless network slice.

18. The wireless communication network of claim 10 further comprising
a machine learning model trained to predict the network conditions based on the network slice KPIs; and wherein:
the NSCF is configured to feed the network slice KPIs into the machine learning model to generate the prediction of the network conditions for the wireless network slice;
the machine learning model is configured to generate a machine learning output that comprises the prediction; and
the NSCF is configured to receive the machine learning output.

19. One or more non-transitory computer-readable storage media having program instructions stored thereon to dynamically manage network slices, wherein the program instructions, when executed by a computing system, direct the computing system to perform operations, the operations comprising:
retrieving network slice Key Performance Indicators (KPIs) that indicate traffic patterns and network parameters related to a wireless network slice;
generating a prediction of network conditions for the wireless network slice based on the network slice KPIs;
updating one or more network slice parameters for the wireless network slice based on the prediction; and
modifying the wireless network slice based on the one or more updated network slice parameters.

20. The one or more non-transitory computer-readable storage media of claim 15 wherein the operations further comprise:
determining the predicted network conditions persist after modifying the wireless network slice based on the one or more updated network slice parameters;
instantiating a new wireless network slice based on the wireless network slice; and
transferring at least a portion of the users from the wireless network slice to the new wireless network slice.
